(19) United States
(12) Patent Application Publication
(10) Pub. No.: US 2015/0100868 A1
(43) Pub. Date: Apr. 9, 2015

(54) SYSTEM AND METHOD FOR SIMULATING DYNAMIC CONTENT BY AUTOMATICALLY UPDATING A STATIC IMAGE WITH APPLICABILITY TO A VIRTUAL BUSINESS CARD

(71) Applicants: Gary Michael Moore, Fishkill, NY (US); Babar Farooqi, Basking Ridge, NJ (US)

(72) Inventors: Gary Michael Moore, Fishkill, NY (US); Babar Farooqi, Basking Ridge, NJ (US)

(21) Appl. No.: 14/049,172

(22) Filed: Oct. 8, 2013

(51) Int. Cl. G06F 17/22; G06F 3/0484; G06F 17/30

(52) U.S. Cl. CPC G06F 17/2235; G06F 17/30896; G06F 3/0484
USPC 715/205

(57) ABSTRACT

Disclosed herein is a system and method for simulating dynamic content by creating and then subsequently updating a static image as the dynamic content changes. Additionally, the system and method further comprises the ability to determine if the desired content has changed, the ability to produce a distributable link, and the ability to create the static images in a specific size and shape. Further, the system and method further comprises the ability to create and edit the original desired content. Particularly, the ability to create an electronic business card, which is comprised of a static and dynamic content.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD

The present application relates to simulating dynamic web content and in particular to virtual business cards.

### BACKGROUND

In spite of the fact that the web is shifting from static (fixed content) to dynamic content, which varies based on parameters provided by a user or a computer program, most email services still only allow people to view static content based on text and included pictures.

The content displayed on a modern website is constantly changing with new blog entries and associated tweets. In today's world, it is imperative that companies and individuals are connected to as many social media channels as possible.

However, sending someone an email that says, “Here is our latest blog post” or “Today's sale price on salmon fillets is $4.99/lb” can become instantly outdated the next time these items are updated. Even sending someone your contact information through an electronic business card becomes outdated the moment you get a promotion or you change jobs.

However, as far as the viewer of the email in concerned, your blog never changes, the price of fish never varies and you never get promoted. The way email is utilized, it is a static history of the world on the day it was sent.

Even for something as simple as a virtual or electronic business card there currently is no efficient method for disseminating updates.

Currently, the most successful business card replacements are electronic business card file formats vCard (or xCard), which are commonly used for cell phone contacts and email attachments. These file formats are used for representing and exchanging a variety of information about individuals and other entities: formatted and structured name and delivery addresses, email address, multiple telephone numbers, photograph, logo, audio clips, etc.

However, there remain many disadvantages to the current system of electronic business card files: electronic business cards are fragmented into many different versions; any change to the information contained in a card will require it to be redistributed to everyone and anything (e.g. cell phone) it was exchanged with; electronic business cards quickly become outdated; for example, changing a surname after marriage, new phone number, new address, and the like will require a person's electronic business card to change everywhere it was saved. However, a major disadvantage is the information contained in an electronic business card file is static. For example, an instant messaging address does not provide online status, and a twitter address does not include the last tweet.

Since the electronic business card forms in common usage are simply file formats, the style is dependent on applications that is viewed/created in. As a result, typical electronic business card forms are also restricted on where they can be used, as they require an application, website, device, and the like to be capable of reading the file format.

The increased number of the social web sites has brought out advancements in web based business cards, but with little success to address the disadvantages of aforementioned electronic business card files formats. Web sites, such as Plaxo, address the fragmented card versions and outdated information, but do not resolve all the other disadvantages of electronic business card files.

After the advancement of smart phones (i.e. iPhone), mobile applications (e.g. Bump) introduced new methods to exchange electronic business cards such as the subscription service proposed in US 20100217614 A1 by Brown et al.; however, they do not address the disadvantages of aforementioned electronic business card files formats. Additionally, unless every one of your contacts agrees to subscribe and use their update service your job history will remain your static history for all time.

Even industry leading companies like Amazon.com have yet to figure out a way to efficiently send dynamic information to consumers through email. For instance, if you go on Amazon's website and you see something that a friend of yours might like then you can send them an email from their site. The email will include a link to a downloadable picture of the product as well as included pricing and inventory information. However, since the pricing and inventory information is included as text, every email includes the following disclaimer from Amazon: “Please note that product prices and availability are subject to change. Prices and availability were accurate at the time this e-mail was sent; however, they may differ from those you see when you visit Amazon.com.”

### SUMMARY

In order to overcome the deficiencies in the prior art, a system and method are described herein.

The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The embodiments described a system and method for simulating dynamic content by creating and then subsequently updating a static image as the dynamic content changes, which does not require a web browser to be viewable.

The system comprises a network device operating within a network that is capable of viewing an image stored within the network, the ability to create and store an image of desired content on the network, the ability to create a distributable link to the stored image on the network, the ability to determine if the desired content has changed and the ability to create an new image of the desired content that replaces the previously stored image.

The system comprises the ability to specify a specific size and shape of the image to be created.

The link that is distributable is comprises a URL to the associated image, an alternative hyperlink to the original content, alternate text in the event that the image is not displayed and sizing information.

The ability to determine if the if the desired content has changed comprises the ability to check if an end user has provided input that the said simulated image should be updated, perform textual comparison, image comparison, checking status, and initiated based upon a periodic timer.

The system further comprises not only the ability to create an image of the desired content but also the ability to create and subsequently edit the desired content.

Particularly, the system comprises the ability to create an electronic business card, which is comprised of a static and dynamic content.

The method comprising determining the size and shape of a simulated image that will represent some specific desired content, creating and storing a simulated image of the desired content on a network, creating a distributable link to the desired content and then determining if said specific desired content has changed and if so regenerating a new image and replacing the old one.

The link that is distributable comprises a URL to the associated image, an alternative hyperlink to the original content, alternate text in the event that the image is not displayed.

Determining if said specific desired content has changed comprises of the ability to check if an end user has provided input that the said simulated image should be updated, perform textual comparison, image comparison, checking status, and initiated based upon a periodic timer.

The method further comprising not only creating an image of the desired content but also creating and subsequently editing the desired content.

Particularly, the method comprises the creating an electronic business card, which is comprised of a static and dynamic content.

### BRIEF DESCRIPTION OF THE DRAWINGS

FIG. 1 illustrates a networked device in communication with a network;

FIG. 2 is a block diagram showing an embodiment of the present invention;

FIG. 3 is a block diagram showing a second embodiment;

FIG. 4 illustrates the anatomy of a dynamic virtual business card;

FIG. 5 illustrates the components for creating a dynamic virtual business card.

### DETAILED DESCRIPTION

The embodiments described a system and method for simulating dynamic content by creating and then subsequently updating a static image as the dynamic content changes, which does not require a web browser to be viewable.

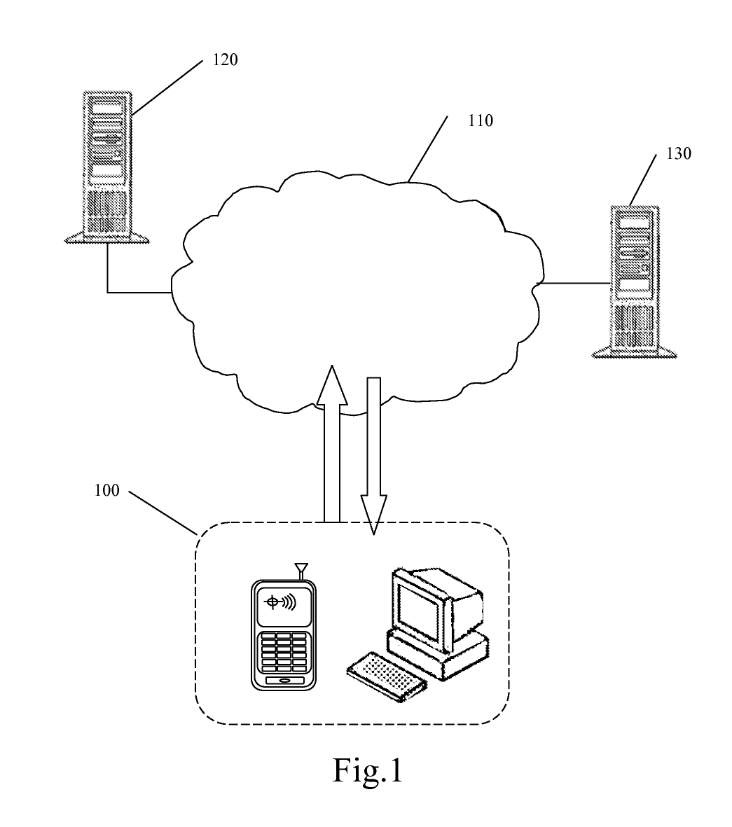

In FIG. 1, a networked device 100 is pictured interacting with a network, which is generally depicted by cloud 110 and is linked to a plurality of external storage units 120 and 130. The networked device 100 could be either a mobile device or a stationary device such as a standalone computer or a server terminal. However, what is essential is that it is capable of having two-way communications through the cloud 110 in order to request information of and receive from plurality of external storage units 120 and 130. Specifically, the networked device 100 must be capable of viewing an image from plurality of external storage units 120 and 130.

It is appreciated that the network hardware may take many forms, for example, fiber optics, wireless links, and even satellite links, all within cloud 110.

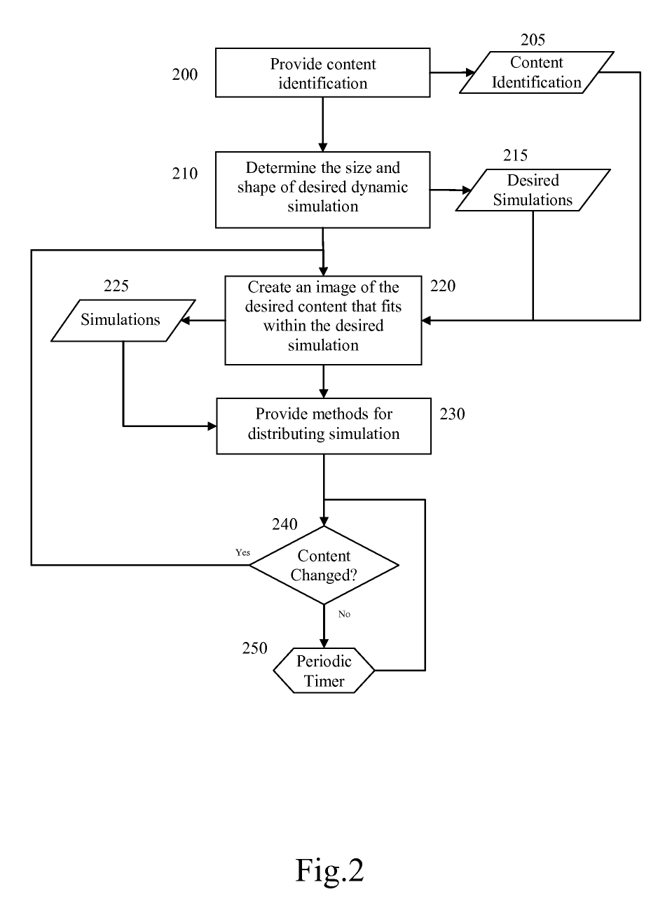

FIG. 2 shows a block diagram of an embodiment in accordance with the present invention. Process 200 provides the end user with the ability to properly identify the content that they want to be simulated, which can be as simple as the end user supplying a URL to an image located on the internet. The table below shows a representative sampling of some of the common forms of social media services and sample content, which can be requested through the use of the API associated with the social media service.

| Service | Content | Identification |
|---|---|---|
| Twitter | Most recent tweets | ScreenName |
| | | Number of tweets to display |
| | | ExcludeReplies (true/false) |
| Flickr | Most recent photos | options.UserId = user.<UserId>; |
| | | options.PerPage = 25; |
| | | options.Page = 0; |
| | | options.SortOrder = |
| | | FlickrNet.PhotoSearchSortOrder.Date |
| | | PostedDescending; |
| Pandora | Music that someone | Accessed via feed: |
| | is listening to | http://feeds.pandora.com/feeds/people/ |
| | | <userID>/recentactivity.xml using a |
| | | username. Note: The number of results |
| | | returned is not determined by Pandora |
| Pinterest | Collection of things | Accessed via feed: |
| | that are of interest | http://pinterest.com/userID/feed.rss |
| | to someone | using a username. Note: the number of |
| | | results returned is not determined by |
| | | pinterest |

Other forms of identification may include date and time (e.g. every Monday at 8 AM) as well as tag, genre, image size . . . etc. It is anticipated that process 200 will be comprised of fixed methods of identification (where the user responds to prompts related to know sources) as well as freeform identification where the user supplies the specific parameters (such as the specific coordinates on a web page.

The parameters needed to identify the content will be stored in content identification database 205.

Process 210 is used to determine the size and shape of the desired dynamic simulation. The parameters related to the size could be a fixed size, predetermined based upon the type of content, calculated based upon the actual content (e.g. display the entire content of the last 5 tweets based on a specific font being used and a specific number of characters per line) and/or freeform capabilities such as where a user actually uses the mouse to circumscribe the area that they want displayed.

The parameters identified in process 210 will be stored in desired simulation database 215.

Process 220 will use the information from database 205 and 215 to create an image of the desired content that fits within the desired simulation. If the desired content is an image already then process 220 may simply copy the image into simulation database 225. However, if the image is in an incompatible format or otherwise needs to be resized in can be processed as part of process 220 using one of the standard image processing tools such as ImageMagik's (http://www.imagemagick.org/script/montage.php) command line tool montage.

However, if the content does not already exist as an image (e.g. the most recent blog post) then process 220 will first convert the desired content to an image. A simple way of doing this would be to simply pull up the desired content on the screen and then use one of the screen capture tools such as Snagit or Fireshot. However, a more sophisticated approach would be to generate the image through a process such as vector conversion based on knowing the content of the text to be displayed.

The image created in process 220 will be stored in simulation database 225. Additionally, along with the image may be any related links in order for an end user to navigate to the actual content.

Process 230 will use the information from simulation database 225 to provide methods for the user to distribute the simulation such as simply making the URL of the image stored in simulation database 225 available to providing embedded links with alt image text, long description, sizing information (height, width, iframes) . . . etc and hyperlinks to either the actual content or hyperlinks to other simulated content.

Decision 240 will be used to determine if the content has changed. A simple method is simply to look and see if the end user has provided a notification to the system that the content was changed and if so then the system would automatically cycle back to process 220. The manner of notification by the end user could be comprised of something as simple as them clicking on an update button. Other methods of determining if the content has changed include simple textual comparison such as does the text of the current most recent tweet match the text of the alt image text stored in simulations database 225. A more sophisticated approach might be to do image comparison, such as using the Structural Similarity Image Metric (SSIM), outlined in the 2004 paper Image Quality Assessment: From Error Visibility to Structural Similarity by Wang, et al, which is hereby incorporated by reference, to determine if the stored image in simulation database 225 matches what would be currently generated.

Other approaches comprise to periodically generate new images after a specific length of time has passed (e.g. once a week or someone's birthday has been reached), and checking status: using a RSS feed, using REST API (which are APIs that return status indicators), or more sophisticated techniques such using an HTML Proxy, possibly in conjunction with a browser plug-in, to capture data changes on external sites (e.g. monitoring facebook status changes or new tweets on twitter).

The use of a HTML Proxy, or its equivalent, may be particularly useful as the system starts to scale, since continuously polling a particular website for tens of thousands of users may cause difficulties. Although the specifics for each website would need to be specifically programmed, the methodology for creating an HTML Proxy can be found in HTTP: The Definitive Guide, authors David Gourley et al., publisher O'Reilly Media, Inc. (2009), ISBN 1449379583, 9781449379582 and for creating a browser plug-in can be found in the book Www Plug-Ins Companion, authors: Mark Robbin Brown et al., publisher: Que Pub (November 1996), ISBN-10: 0789708450, ISBN-13: 978-0789708458, which are both hereby incorporated by reference.

It should be noted that after process 220 is run an initial time that any subsequent time that that process 220 is executed it will store the new simulation in the same location within simulations database 225 and therefore any previously distributed link will now be pointing to the new image.

Additionally, although process 230 is shown within the “Yes” content change cycle, it is not necessary that it actually do anything on subsequent iterations. It is merely in the process because it may be desirable to modify some of the link attributes, such as the date created, so that subsequent distribution of the link are based upon the most current version.

Periodic Timer 250 provides a mechanism to periodically reassess whether or not the content has change by continuously cycling back to decision 240. The interval could be a fixed interval, dependent on the type of content, dependent on the frequency of changes or based upon parameters such as the criticality of the update for example an emergency alert might have an extremely short interval.

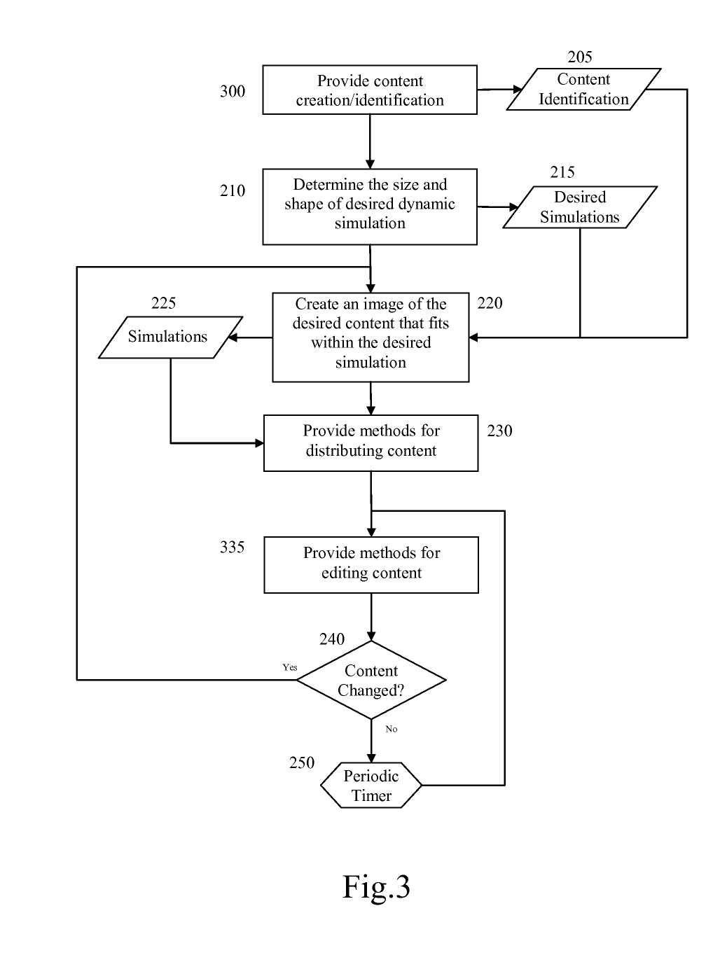

FIG. 3 is almost identical to FIG. 2 except process 200 has been replaced with process 300 and process 335 has been added. Where FIG. 2 represents an embodiment of an open system where the content is created and modified external to the system, FIG. 3 represents a closed system in which the content is created/edited within the embodiment.

In process 300, rather than simply identifying the content, the content is also created at this step. Similarly process 335 was inserted between process 230 and decision 240 to allow for content to be edited and periodic timer 250 still cycles back to the process that comes after process 230.

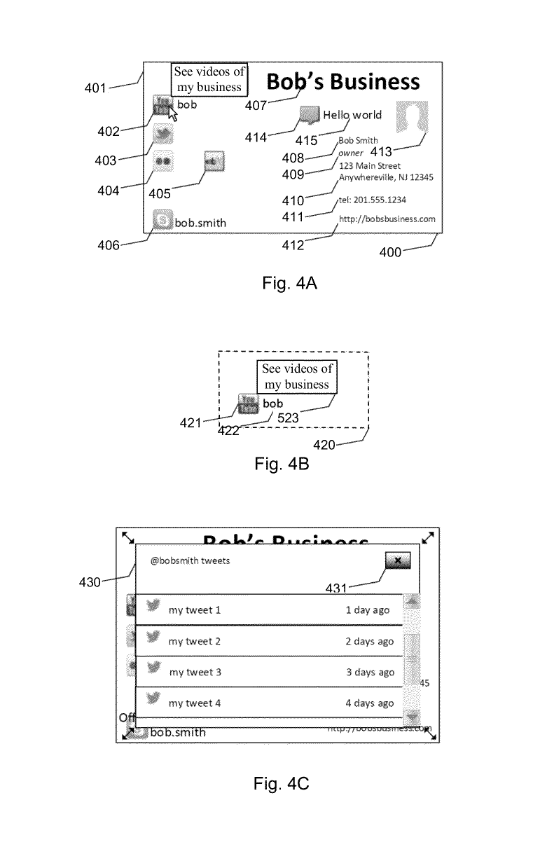

The embodiment represented in FIG. 3 would be particularly applicable to creating electronic business cards FIG. 4a and FIG. 4b and FIG. 4c illustrate an exemplary dynamic virtual business card 400, dynamic virtual business card field 420, and data feed apparatus 430, respectively. A dynamic virtual business card 420 may have a plurality of fields 402-414.

A field 420 may comprise a description 423, a static value 422 or dynamic value 415, and icon 421. A description 423 may be triggered by an event to hide or show additional information about a field that may not fit on a dynamic virtual business card 400. An icon 421, static value 422, or dynamic value 415 may be configured to be hidden or shown on a dynamic virtual business card 400.

A data feed apparatus 430 may expand or collapse inside a dynamic virtual business card 401 or open a new window when a field 420 is selected (tapped, clicked, hovered on, and the like). A data feed apparatus 430 may be closable 431 to view a virtual business card 401. A data feed apparatus 430 displays the latest data from the web site associated with a selected field 420.

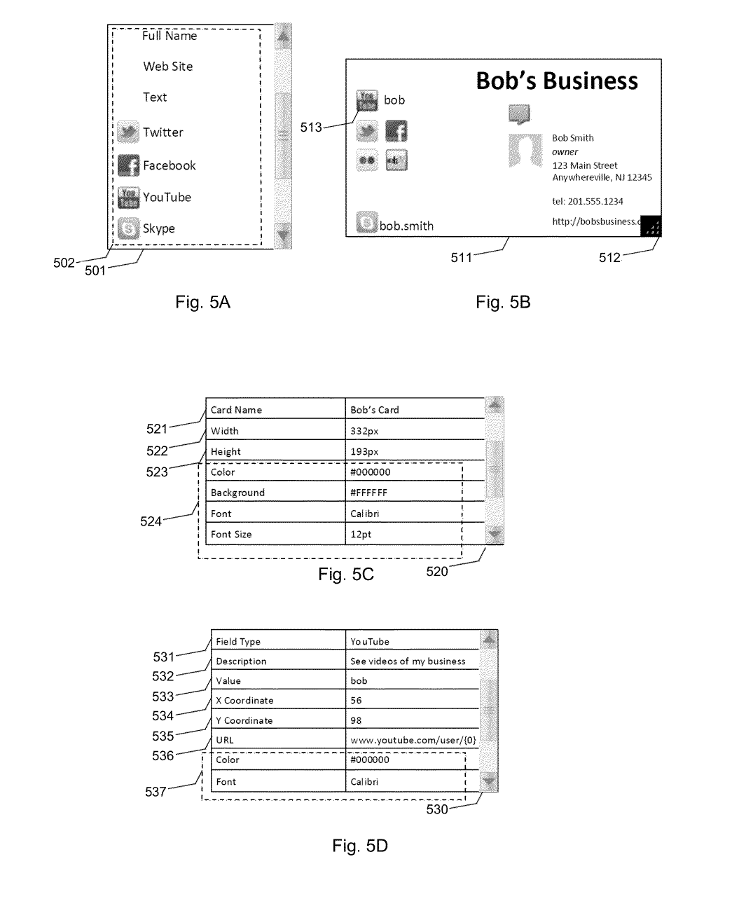

FIG. 5a, FIG. 5b, FIG. 5c, and FIG. 5d illustrate exemplary apparatuses for creating or editing a dynamic virtual business card. A dynamic virtual business card editor may comprise of a field type selector 501, dynamic virtual business card 511, dynamic virtual business card editable properties 520, and field editable properties 530. Other options for creating dynamic virtual business cards include a wysiwyg html editor.

A field type selector 501 may comprise of all field types 502 that may be added or removed to or from a dynamic virtual business card 511, respectively. A dynamic virtual business card 511 may be resizable 512. A dynamic virtual business card 511 may be editable and it may have a plurality of fields that are editable.

FIG. 5c is an exemplary embodiment of a dynamic virtual business card's editable properties 511. A dynamic virtual business card's 511 editable properties 520 may comprise of a name 521, width 522, height 523, and a plurality of styles 524.

FIG. 5d is an exemplary embodiment of a field's editable properties 513 properties. A field's 513 editable properties 530 may comprise of a field type 531, a description 532, a value 533 of any type (string, integer, date, boolean, object, and the like), location 534-535 on the dynamic virtual business card 511, URL 536, and a plurality of styles 537.

Electronic business cards are just one of many applications for which the embodiments described may be utilized. Other anticipated applications include: advertisements, maps (e.g. current location profile) and online profiles (e.g. dating sites, corporate profiles, user profiles on a chat site).

It should be recognized, however, by those skilled in the art, that changes or modifications may be made to the above-described embodiments without departing from the broad inventive concepts of the invention. It should be understood, therefore, that the present invention is not limited to the particular embodiments disclosed herein, but is intended to cover all modifications and changes that are within the scope and spirit of the appended claims.

We claim:

1. A system for simulating dynamic content, comprising:
a network device operating within a network;
said network device is capable of viewing an image within said network;
within said network is an ability to identify desired content for which a simulation is desired;
within said network is an ability to create and store a simulated image of said desired content, which does not already exists as an image;
within said network is an ability to create a distributable link that allows said networked device to view said simulated image;
within said network is an ability to determine if the desired content has been changed and to create and store a new simulated image of the desired content that replaces the previously stored image of said desired content and becomes what said link is connected to.

2. The system of claim 1 where said ability to create an image comprises the ability to specify a specific size and shape.

3. The system of claim 1 where said ability to create a distributable a link is comprised of a URL to the associated image, an alternative hyperlink to the original content, alternate text in the event that the image is not displayed, sizing information.

4. The system of claim 1 where said ability to determine if the desired content has changed has the ability to compare said simulated image to the current state of the desired content.

5. The system of claim 1 where said ability to determine if the desired content has changed has the ability to perform a textual comparison.

6. The system of claim 1 where said ability to determine if the desired content has changed has the ability to check status.

7. The system of claim 1 where said ability to determine if the desired content has been changed comprises the ability to check if an end user has provided input that the said simulated image should be updated.

8. The system of claim 1 further comprises a periodic timer and where said ability to determine if the desired content has been changed is initiated based upon said periodic timer.

9. The system of claim 1 further comprises within said network the ability to create said desired content.

10. The system of claim 1 further comprises within said network the ability to modify said desired content.

11. The system of claim 1 where said desired content is an electronic business card.

12. The system of claim 11 where said electronic business card further comprises a plurality of data feed apparatus, which are selectable and provide dynamic content.

13. The system of claim 11 where said electronic business card further comprises a plurality of static and dynamic data fields, which are capable of containing information discoverable by said network device.

14. A method for simulating dynamic content, comprising:
determining the size and shape of a simulated image that will represent some desired content;
creating and storing a simulated image of said desired content that conforms to said previously determined size and shape;
storing said simulated image on a network in an accessible location;
creating a distributable link that allows a networked device to view said simulated image on a said network;
determining if said specific desired content has changed and then regenerating a new image that conforms to said previously determined size and shape and the replacing the simulated image with said new image.

15. The method of claim 14 where said creating a distributable link that allows a networked device to view said simulated image on a said network comprises a URL to the associated image, an alternative hyperlink to the original content, alternate text in the event that the image is not displayed, sizing information.

16. The method of claim 14 where said determining when said desired content has changed comprises comparing said simulated image to the current state of the desired content.

17. The method of claim 14 where said determining when said desired content has changed comprises performing a textual comparison.

18. The method of claim 14 where said determining when said desired content has changed comprises checking status.

19. The method of claim 14 where said determining when said desired content has changed is initiated based on an end user's input.

20. The method of claim 14 where said determining when said desired content has changed is initiated based upon a period event.

21. The method of claim 14 further comprising creating said desired content.

22. The method of claim 14 further comprising editing said desired content.

23. The method of claim 14 where said desired content is that of an electronic business card.

24. The method of claim 23 where said electronic business card further comprising a plurality of data feed apparatus, which are selectable and provide dynamic content when selected.

25. The method of claim 23 where said electronic business card further comprising a plurality of static and dynamic data fields.
